(19) United States
(12) Patent Application Publication
(10) Pub. No.: US 2004/0231513 A1
(43) Pub. Date: Nov. 25, 2004

(54) System for inline stripping of soil contaminants

(76) Inventors: James A. Perkins, Pleasanton, CA (US); Rudolph R. Millan, Walnut Creek, CA (US); Shelby Suzanne Lathrop, Vacaville, CA (US)

Correspondence Address: LUEDEKA, NEELY & GRAHAM, P.C., P O BOX 1871, KNOXVILLE, TN, 37901, US

(21) Appl. No.: 10/828,843

(22) Filed: Apr. 21, 2004

Related U.S. Application Data
(63) Continuation of application No. 10/097,098, filed on Mar. 12, 2002.

(51) Int. Cl. B01D 19/00

(52) U.S. Cl. 95/263

(57) ABSTRACT

The specification discloses a method for treatment of contaminated groundwater. According to one embodiment, the method includes as a first step extracting a contaminated subterranean fluid from a contaminated well. The fluid is then stripped by passing the fluid through an inline stripper so that volatile contaminants are transferred from a liquid phase to a vapor phase. Next, the liquid phase and the vapor phase are separated into two process streams. The volatile contaminants are then recovered from the vapor phase process stream, destroyed, or if permissible, discharged from the vapor stream. The invention may suitably be used in the treatment of subterranean fluids which are extracted as a two-phase flow or in the treatment of which are substantially a liquid phase having volatile contaminants dissolved therein.

### FIELD OF THE INVENTION

The invention relates to the field of soil and groundwater treatment and, in particular, to a system for treating sites contaminated with volatile organic contaminants.

### BACKGROUND OF THE INVENTION

The treatment and cleanup of chemical contaminants in the soil and in groundwater has been and remains an issue of great concern. Increasingly stringent environmental regulations require that large numbers of relatively small contaminated sites be remediated. For instance, leakage of gasoline and other fuels from underground storage tanks has resulted in a need to remediate numerous service station and other fuel storage sites.

The contaminants of concern in these sites are usually volatile organic contaminants or VOCs. A VOC of particular concern is methyl tertiary butyl ether (MtBE), a common gasoline additive. Due to its aqueous solubility properties, and the fact that even trace amounts of this compound can spoil water for drinking and other purposes, a relatively small amount of MtBE can contaminate an enormous volume of groundwater.

The conventional approach for remediating an MtBE-contaminated site involves treating the contaminated groundwater fluid in a large evaporator column to remove the MtBE and other contaminants from the groundwater. However, such columns are unsightly and expensive, and hence often not well suited to treatment of large numbers of relatively small contaminated sites in many populated areas.

It is therefore an object of the invention to provide a system for removing volatile organic contaminants from groundwater.

Another object of the invention is to provide a system which will effectively remove methyl tertiary butyl ether from contaminated groundwater containing small or even trace amounts of the compound.

Still another object of the invention is to provide a groundwater treatment system which is relatively small, compact, and inexpensive.

An additional object of the invention is to provide a groundwater treatment system which is simple and reliable.

### SUMMARY OF THE INVENTION

With regard to the foregoing and other objects and advantages, the present invention provides a method for the treatment of groundwater in a subterranean formation contaminated by the presence of volatile organic compounds (referred to herein at times as “VOC's”). According to one embodiment, a well is established extending from the ground surface to a downhole location adjacent contaminated groundwater in the subterranean formation in order to allow withdrawal of contaminated groundwater to the surface for treatment. Contaminated groundwater is conducted from the downhole location through the well to the surface and is then stripped by expanding the flow in an inline stripper to induce transfer of VOC's from the groundwater to a vapor phase. Thereafter, the groundwater and the vapor phase are separated into substantially liquid only and substantially vapor only process streams.

The method may also include separating volatile organic compounds from the vapor process stream.

In certain embodiments, it is preferred that the groundwater withdrawn through the well is withdrawn to the surface for treatment as a two-phase fluid having a substantially liquid portion and a substantially vapor portion to promote separation of VOC's to the vapor phase, especially in the stripper. It is also preferred in certain embodiments that a subatmospheric pressure be imposed upon at least a portion of the groundwater within the well to promote withdrawal of the same to the surface and separation of VOC's.

In another aspect, the invention provides an apparatus for the treatment of groundwater in a subterranean formation contaminated by the presence of VOC's including VOC's dissolved in the groundwater. According the one embodiment, the apparatus includes a well extending from the ground surface to a downhole location adjacent contaminated groundwater in the subterranean formation in order to allow withdrawal of contaminated groundwater to the surface through the well. The apparatus further includes a stripper unit containing an inline stripper connected in flow communication with the well for stripping VOC's from the groundwater by means of expansion of the flow inducing transfer of VOC's from the groundwater to a vapor phase. Means are also included for causing a flow of contaminated groundwater from the subterranean formation into and through the well to the surface and through the inline stripper of the stripper unit so that material exiting the inline stripper contains a vapor phase enriched in volatile organic compounds and a liquid phase depleted in volatile organic compounds. The stripper unit further comprises a collector connected in flow communication with material exiting the inline stripper for collecting the liquid phase and the vapor phase in separate substantially liquid only and substantially vapor only process streams.

The inline stripper of the stripper unit preferably includes a flow-through conduit having an inlet into which groundwater flows and an exit from which the vapor and liquid phases pass to the collector. The conduit includes a flow expander section downstream of the inlet through which groundwater flows and is released into an expanded cross-sectional area such that, upon entering the expanded cross-sectional area, a turbulence, mixing and misting of the flow is induced to promote separation of VOC's from the groundwater into the vapor phase. A source of compressed gas is connected in flow communication with the inline-stripper for introducing a flow of compressed gas into the stripper conduit in the expander section upstream of the expanded cross-sectional area in order to further promote separation of VOC's from the ground water into the vapor phase.

The invention especially well-suited for treatment of VOC-contaminated groundwater containing methyl tertiary butyl ether (MtBE). The invention is capable of removing at least about 80% of the volatile organic compounds from the groundwater to the vapor phase in a single pass through the stripper.

It is also preferred in certain embodiments that the collector portion of the stripper unit be provided by a knockout vessel. The knockout vessel is configured and dimensioned to promote separation of the liquid and vapor phases by the force of gravity acting upon the liquid phase.

In still further embodiments, it is preferred that at least a portion of the liquid phase passing out of the on-line stripper and/or collected in the collector be cycled back to groundwater flowing into the inline stripper and/or be conducted through an additional stripper unit for successive or series treatment of the liquid portion of the groundwater.

In still another aspect, the invention provides a method for treating groundwater from a subterranean formation wherein the groundwater is contaminated by the presence of dissolved volatile organic compounds (VOC's), such as methyl tertiary butyl ether (MtBE), which comprises as a first step conducting a flow of the groundwater through a conduit. In the conduit, the flow of the groundwater is expanded to promote separation of VOC's from the groundwater. As used herein, “expanded,” “expansion,” and other forms of the root “expand” refer to and include a process step and associated apparatus in which the flow is rapidly decelerated from a first flow velocity to a substantially lower flow velocity than the first flow velocity and in an expanded cross-sectional area of the stripper conduit containing a gas or vapor space. Rapid or abrupt deceleration of the flow velocity of the groundwater in conjunction with entry of the material into the expanded cross-sectional areas causes substantially increased turbulence, mixing, and misting ofthe groundwater to induce transfer of dissolved VOC's from the groundwater to a gas phase in the gas space within the expanded area so that the expanded area ofthe conduit contains a two-phase flow comprising a flowing liquid phase with a reduced VOC content compared to that of the entering groundwater and a flowing gas phase including VOC's transferred thereto from the groundwater entering the expanded area. Thereafter, the flowing liquid and gas phases are conducted from the stripping conduit into a collector vessel in which the liquid and gas phases are effectively separated and collected in separate and distinct substantially liquid and substantially vapor only flow streams exiting the collector for further treatment and/or disposal.

Preferably, the ratio of the first higher flow velocity to the lower flow velocity is from about 2 to about 40, most preferably from about 10 to about 15. The flow velocity may be accelerated to the first flow velocity by conducting the groundwater through a reduced cross-sectional area in relation to the cross-sectional area of the stripper conduit in an expander section upstream thereof carrying groundwater flowing at the first relatively lower flow velocity and in relation to the expanded cross-sectional area of the stripper conduit containing a gas or vapor space downstream of the reduced cross-sectional area.

Preferably the ratio of the cross-sectional areas of the expanded cross-sectional areas portion to that of the expander section of the conduit just upstream thereof is from about 10 to about 30, most preferably from about 5 to about 50. In comparison to the lengths of the various portions of the conduit, it is preferred that the ratio of the length of the expanded cross-sectional area portion of the conduit in relation to that of the expander area just upstream thereof is in the range of from about 10 to about 100. The foregoing preferred dimensional characteristics of the conduit relate, in essence, to the preferred ratios of the lengths and widths of the sections in terms of both their relative volumes and the space needed within the expanded cross-sectional area for the necessary deceleration of the flow and associated effects for separation of VOC's including MtBE into the vapor phase in the gas space. However, it will be apparent to those of ordinary skill that other ratios of length to cross-sectional area may be used depending on those related factors of entering flow velocity, the composition of the flow in terms of the amount of liquid and gas in distinct phases (i.e., the degree or extent of two-phase flow), and the overall mass flow rate, and the like.

In at least one embodiment of the invention, the method comprises pumping groundwater from the subterranean area into the stripper unit so that groundwater released into the expanded cross-sectional area is under greater than atmospheric pressure.

In certain embodiments it is also preferred that the method further comprise injecting compressed gas into the groundwater flowing through the expander area. More preferably, this gas comprises compressed air at a pressure in the range of from about 20 to about 150 psig and more preferably from about 50 to about 100 psig. The compressed gas may also be preferably supplied at a volumetric flow ratio in relation to the flow of groundwater in the range of from about 10 to about 200 and more preferably in the range from about 10 to about 50.

In still another embodiment according to the invention, the method also includes, following separation of the gas and liquid phases, recycling at least a portion of the separated liquid phase so that the recycled liquid phase is mixed with groundwater entering the stripping conduit. Still more preferably the step of repeating comprises conducting the liquid phase through a second stripper conduit in the manner as the groundwater in the first conduit wherein the second conduit is arranged in series, flow communication with the first stripper conduit.

### BRIEF DESCRIPTION OF THE DRAWINGS

above and other aspects and advantages of the invention will now be further described in conjunction with the accompanying drawings in which:

FIG. 1 is a schematic view illustrating the components of a groundwater remediation system according to one embodiment of the invention;

FIG. 2 is an elevational view of an inline stripper device in accordance with one aspect of the invention;

FIG. 3 is a cross-section view of an air amplifier suitable for use in accordance with one embodiment of the invention;

FIG. 4 is an elevational view ofan exemplary extraction well in accordance with one embodiment of the present invention;

FIG. 5 is a schematic view illustrating a series of inline strippers and separators according to a preferred embodiment of the invention;

FIG. 6 is a schematic view illustrating a series of inline strippers according to a preferred embodiment of the invention; and

FIG. 7 is a schematic view illustrating recycle of stripped extract according to another preferred embodiment of the invention.

### DETAILED DESCRIPTION OF THE INVENTION

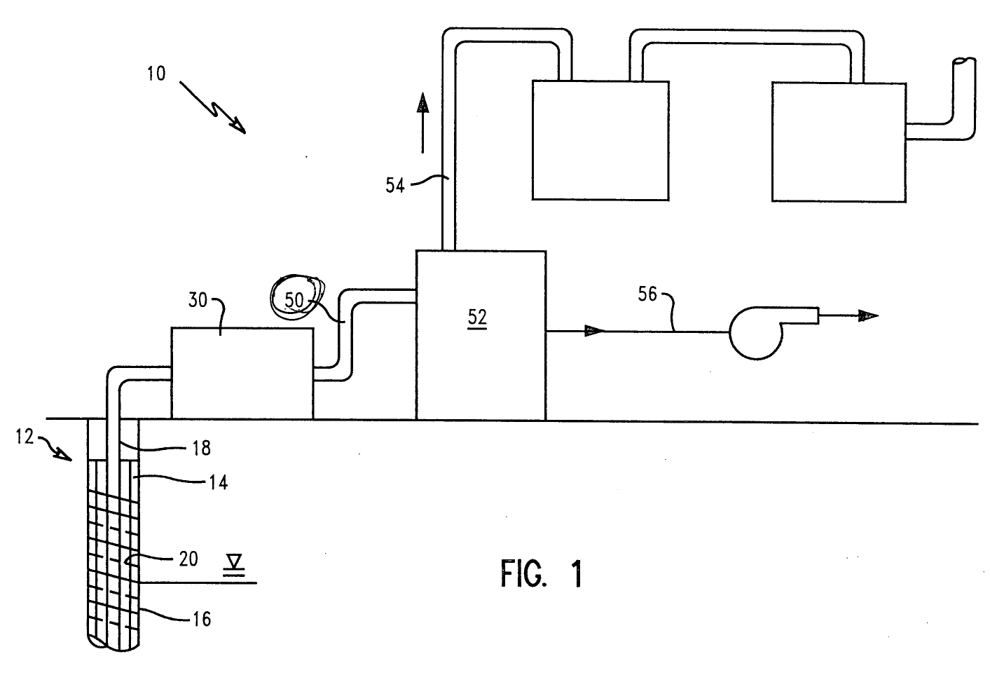

Referring now to the drawings, various aspects of the invention will now be described with initial reference to FIG. 1 wherein there is shown a groundwater treatment system according to one embodiment of the invention.

The treatment system may suitably be used in conjunction with treatment of a site having soils and groundwater contaminated with organic materials, particularly volatile or semi-volatile organic contaminants. For instance, the treatment system may be used to treat groundwater which has been contaminated with volatile organic contaminants (VOCs) which have leaked from an underground fuel storage tank.

An especially beneficial use of the invention is believed to be in treatment of groundwater contaminated by the presence of VOCs, particularly MtBE, in the process of removal of the same from subterraneous formations using various well systems. A great variety of such well systems are known and may be used in the practice of the present invention for removal of contaminated groundwater and vapor to the surface from the water table, the vadose zone, and the zones or areas of transition between the water table and the vadose zone known as unsaturated or partly saturated zones. Examples of such well systems in or in connection with which the invention may be used included those described in U.S. Pat. Nos. 4,435,292 to Kirk et al.,U.S. Pat. Nos. 5,400,858 and 5,452,765 to Blanchard et al. and U.S. Pat. No. 6,146,104 to Mastroianni et al, the disclosures of which are incorporated herein by reference. Those of ordinary skill are believed to be well-versed in the use of the above and other similar subterranean groundwater/ vapor removal technologies in connection with which the invention may be used.

As used herein, a contaminant is generally considered “volatile” if it exhibits a Henry's law constant of 0.001 or greater. Examples of volatile organic contaminants which may be treated according to the present invention include benzene, bromobenzene, carbon tetrachloride, chlorobenzene, decane, dichlorobenzene, dichloroethane (DCA), dichloroethylene (DCE), dichloropropane (DPC), ethylbenzene, tetrachloroethylene (PCE), methyl ethyl ketone (MEK), methyl tertiary butyl ether (MtBE), trichloroethylene (TCE), toluene, vinyl chlorides, and xylenes.

As mentioned earlier, the treatment system is particularly well adapted for use in the recovery of methyl tertiary butyl ether (MtBE) from groundwater. MtBE is a gasoline additive which is often a problem contaminant at sites contaminated by leaking fuel storage tanks.

The treatment system may be used in the recovery of MtBE or other VOCs at groundwater concentrations of any known amount that may be encountered in a contaminated site. These would typically range from about 0.01 ppm up to the solubility limit of the contaminant in water.

The system 10 preferably includes a plurality of extraction wells 12 strategically spaced apart and constructed to appropriate depths for recovery of contaminated groundwater to the surface for treatment. However, only one such well will be illustrated diagrammatically herein for the sake of brevity. It is understood, however, that the system may include a single extraction well 12.

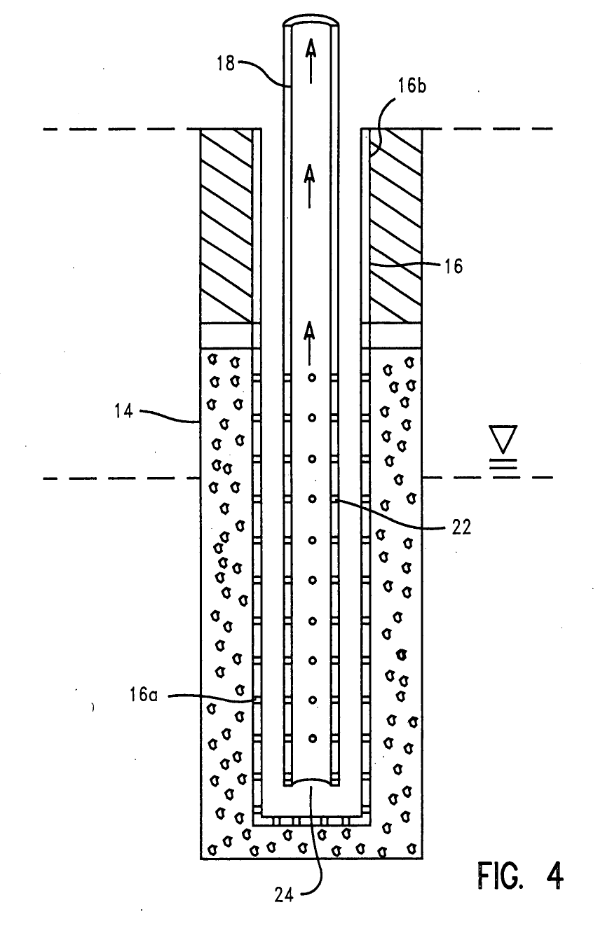

The extraction well 12, which is seen in greater detail in FIG. 4, in the exemplary embodiment is defined by a borehole 14 drilled into the ground from the surface to a position operably adjacent the depth of the contaminated groundwater 20. That is the borehole 14 may extend either into the contaminated groundwater 20 or sufficiently close thereto as to allow removal of the groundwater 20 via the borehole 14. It will be appreciated that the sizing and depth of the well 12 will generally be established in accordance with the location and amount of the groundwater contaminants. Determination of sizing, depth, and all other relevant parameters in connection with construction and proper operation of the well 12 for withdrawing contaminated groundwater is readily accomplished by any person of ordinary skill in the art. For illustration purposes only for removal of contaminated ground water, vapors, etc. associated with a water table located about 10 feet below the surface, well 12 may have a depth of from about 10 to about 25 feet and a diameter of from about 8 to about 12 inches. However, the well bore 12 may range up to 24 inches in diameter and have a depth of up to 35 feet.

The borehole 14 of the extraction well 12 may also include a casing 16, preferably a perforated casing, for support and increased strength and to facilitate passage of groundwater and gases (a/k/a “vapors”) into the well 12 from the adjacent subterranean area. The casing 16 may be formed of either a metal material or a plastic material and typically has a diameter which is somewhat smaller than the overall diameter of the borehole 14. A preferred diameter for the casing 16 is from about 2 to about 12 inches. The casing 16 preferably includes a lower portion 16a which is perforated to aid migration of groundwater and contaminants into the well and an upper portion 16b which is solid and non-perforated for increased support of the well sidewalls. Any gap between the lower portion of the casing and the walls oft he borehole may be filled with a permeable material such as sand while the gap between the non-perforated upper portion and the borehole walls may be filled with a material such as concrete for strength.

Within casing 16, there is preferably an extraction pipe or conduit 18 extending from the surface down into the contaminated groundwater 20 which collects in the extraction well 12. The extraction pipe 18 in the illustrated embodiment may have a diameter of from about 1 to about 4 inches and may include one or more perforations 22 along its length to assist in inducing a two phase flow of extracted fluid (i.e., both gases or vapors and liquids) from within the well and from the area around the well. The use of perforations in an extraction pipe 18 in order to promote a two-phase flow and to assist in removal of groundwater from greater depths is described in commonly assigned U.S. Pat. No. 5,400,858 issued Mar. 28, 1995 to Blanchard et al., the disclosure of which is incorporated by reference. With the teachings of the '858 patent in particular, those of ordinary skill are believed to be capable of properly sizing the conduit 19 according to the various design parameters, dimensions of the well 12, and in the selection, dimensions, and configuration of the perforations for establishing a desired functional two-phase flow in the conduit believed to be important in the practice of certain embodiments of the present invention for separation of VOC's from the groundwater.

Contaminated groundwater 20 and any entrained vapor/gas (hereinafter “extract”) is extracted from the ground through the well 12 and drawn up to the surface via lower opening 24 of the extraction pipe 18 and perforations 22. The extract may be drawn to the surface either as a substantially liquid fluid or as a two phase flow of liquids and vapors. Preferably, the extract is removed through the operation of the well as a two phase flow of liquids and gases.

The extract 20 may be brought up to the surface under the influence of a pump, by applying a vacuum force to the extraction conduit 18, or by a combination of pumping and vacuum forces, and these and other motive forces used to propel fluids to the surface may be applied continuously, cyclically or in a pattern as a unit or with selected wells for achieving the desired pumping action. Preferably the groundwater is extracted by using an above-ground vacuum system to provide a reduced pressure in the extraction pipe.

Pumping action may be applied by a “downhole pump” positioned within the well casing and below the groundwater liquid level within the extraction well. Suitable pumps for use in this application include submersible electric pumps and pneumatically driven pumps in which a fluid chamber is allowed to fill with contaminated groundwater and then compressed air is used to discharge the collected groundwater from the chamber through the extraction pipe and to the surface.

Groundwater may also be withdrawn from the well via vacuum extraction. Vacuum is applied to the extraction pipe via a vacuum source such as a positive displacement blower or a liquid ring pump. The vacuum source is preferably situated at the surface and in fluid flow communication with the extraction pipe.

When a positive displacement blower is used, the blower induces a flow of vapors. from within the extraction well up through the extraction pipe and a portion of the contaminated groundwater is entrained within this vapor flow. The entrained groundwater is drawn through the extraction pipe and to the surface together with the well vapors. Volumetrically, the ratio of vapors to liquids in the extract thereby provided is about 20:1 to about 50:1.

If a liquid ring pump is employed, the groundwater liquid is directly lifted to the surface by the vacuum action of the pump. Thus, a substantially continuous column of groundwater is extracted although some amount of air or other vapors may be drawn into the extraction pipe (such as through perforations 22 in the extraction pipe) and carried to the surface as well.

It is a feature of the invention that the extract is treated using a stripper unit having an inline stripper 30 which is in fluid flow communication with the extraction conduit 18. The inline stripper 30 may be situated either at the surface or within the extraction well. The inline stripper 30 is used to effect or bring about rapid mass transfer of a large fraction of the volatile contaminants in the extract from the liquid phase to the vapor phase prior to separating the liquid and vapor phases.

A preferred inline stripper 30 passes the extract fluid through a venturi-like conduit wherein the fluid flow is first constricted and forced through a narrow throat 32 or nozzle-type structure and then caused to expand upon exit from the throat 32 in an expander section. The resultant expansion produces an enhanced degree of turbulence and mixing in the fluid in the conduit as well as misting when a fluid flow containing an appreciable liquid content passes through the venturi followed by an abrupt expansion and accompanying pressure change. The turbulence, mixing, and misting greatly enlarges the surface area of the vapor liquid interfaces, thereby significantly enhancing the transfer of the volatile contaminants from the liquid phase to the vapor phase.

In certain embodiments of the invention, it is preferred to inject a flow of compressed gas, preferably air, into the extract as it passes through the stripper conduit, most preferably of the nearest point of the throat although compressed air may be injected at other locations as well in accordance with the invention. The compressed air further increases the turbulence and vapor-liquid interface in the fluid. Injection of compressed air is especially preferred if the extracted fluid is substantially a liquid phase as opposed to being a two-phase mixture; however, injecting compressed air in a two-phase mixture is also advantageous and may also be preferred.

The compressed air is preferably injected at substantially ambient temperature, although it may be injected at an elevated temperature (heated or superheated) to promote flashing or separation of any liquid phase VOCs to the vapor phase and to improve the gas conditions for carrying volatiles. In other embodiments, the compressed gas may be injected as a cooled or supercooled fluid to induce more efficient separation of VOC's into the gas phase.

The flow rate and pressure of the injected compressed gas may vary depending on the volume and flow rate of extract and the particular nature of the contaminants. However, the compressed gas flow rate (in the case of compressed air) is typically from about 15 to about 750 cubic feet/minute (cfm) and preferably from about 15 to about 30 cfm, and the pressure of the same is preferably from about 20 to about 150 psig. Most preferably, the flow rate is about 100 cfm and the pressure is about 90 psig.

The amount of compressed gas supplied in relation to that of the extract moving through the conduit in the stripper 30 may also vary depending on the amount of entrained gas in the two-phase flow and other factors. Armed with knowledge of the invention, those of ordinary skill will be able to determine the appropriate mass flow ratio of injected compressed gas, its content or make-up, and its conditions (pressure, temperature, etc.) to achieve optimum conditions for the desired separation.

By way of illustration, for a two phase extract flow including a flow of about 2 gallons per minute (gpm) of liquids and about 20 cfm of vapors at a temperature of about 60° F. through a 2 inch diameter conduit in the stripper 30 and containing about 10 ppm dissolved VOCs, compressed air at a flow rate of about 20 cfm, a pressure of about 90 psig, and a temperature of about 80° F. is admitted into the conduit.

When the compressed gas is compressed air, it is preferred that steps be taken to insure the air admitted to the stripper conduit is itself substantially clean with all (or substantially all) contaminants removed. For example, compressed air often contains an appreciable amount of oil from the compressor system and this oil component should be removed and the air filtered before the air is used in the stripper 30.

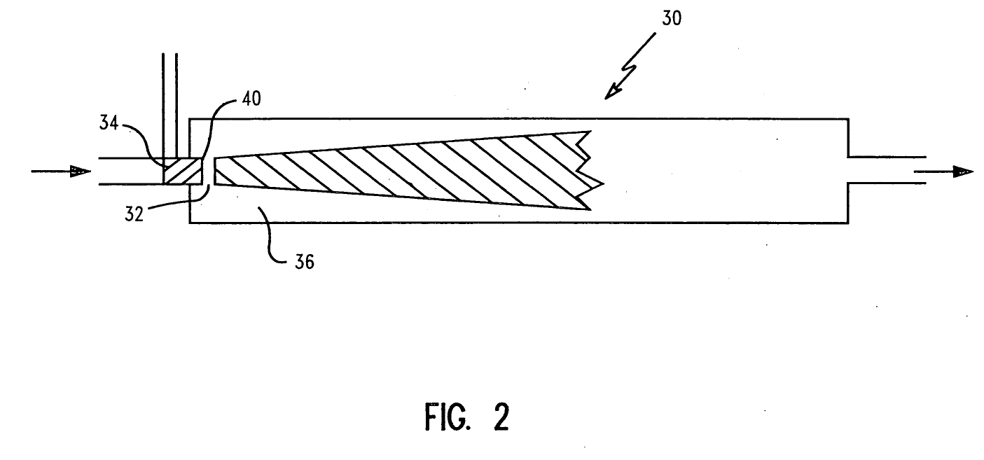

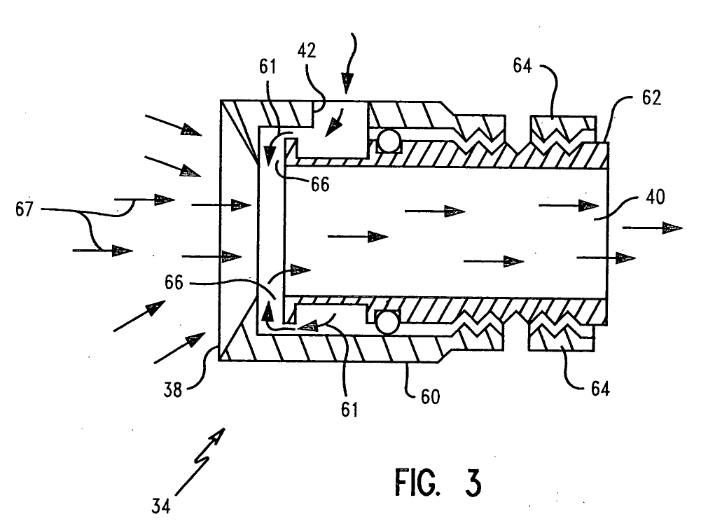

Numerous structures and/or devices may be used to provide the stripper venturi. One suitable venturi shape may be provided by employing a so-called “air amplifier” 34 and an elongate conduit 36 connected in flow communication with the downstream end at amplifier 34 which fictions as an expansion chamber as shown in FIG. 2. An air amplifier 34 is a device having a relatively large inlet 38 and a relatively small outlet 40 the latter of which acts as a venturi throat. The length of the venturi throat 40 is typically from about 2 to about 6 inches. The air amplifier 34 accelerates the flow of fluid as it passes through the outlet throat 40 and is ejected out. The amplifier 34 may also include a port 42 for compressed gas injection as discussed above. Suitable air amplifier devices are available from Artx of Cincinnati, Ohio, under the tradename ARTX Variable Air Amplifier, Models 15008, 15015, and 15030. A suitable air amplifier is shown in cross sectional in FIG. 3.

As may be seen in FIG. 3, the air amplifier 34 includes an elongate, generally cylindrical outer housing 60 and an elongate inner sleeve 62 which is received within the housing 60 and threadedly attached thereto. A locking screw ring 64 holds the assembly together.

Compressed air enters the housing through the injection port 42 and travels along a path as by arrows 61 between the sleeve 62 and the housing 60 and is injected through a gap into the flow of contaminants passing through the air amplifier. An O-ring seals the sleeve 62 and housing 60 forward of the injection port. By rotating the sleeves about its threads, the sleeve may be adjusted forward or back within the housing and the size of the air injection gap 66 may be consequently increased or decreased. Those of skill will appreciate that the flow of compressed air into the amplifier may thereby be regulated.

The injection of the compressed air into the air amplifier produces a venturi-like effect. A vacuum force is induced behind the air injection point which pulls fluids along the direction of arrows 67 into the air amplifier inlet. At the same time, fluids are rapidly accelerated out the air amplifier outlet.

The sizing of the air amplifier 34 will vary with the extract flow rate. However, suitable amplifiers for most applications typically have an inlet diameter of from about 2 to about 5 inches and a diameter at the smallest cross-sectional area of the throat 40 of from about 1 to about 4 inches. Since the conduit through the amplifier is preferably circular in cross-section, this translates to inlet and outlet cross-sectional areas of from about 3 to about 20 square inches for the inlet and from about 1 to about 12 square inches for the outlet.

As the extract fluid exits the air amplifier 34, it enters the expansion chamber 36 portion of the stripper conduit in which the aforementioned turbulence and misting occurs and is allowed to propagate. The expansion chamber 36 is also preferably circular in cross-section and has a cross-sectional area that is preferably from about 5 to about 50 times larger than that of the throat outlet 40 and more preferably from about 10 to about 30. Accordingly, for a throat outlet 40 cross-sectional area in the range of from about 1 to about 12 square inches the cross-sectional area of the chamber may range from about 10 to about 200 square inches. The expansion chamber 36 has a length of from about 2 to about 10 feet. The expansion chamber. 36 may have a substantially constant diameter along its length or, more preferably, may have a generally conical shape with a narrower diameter adjacent the air amplifier 34 and a larger diameter further away from the air amplifier 34.

Within the expansion chamber 36, the turbulence, mixing, and misting as well as the pressure effects associated with the change in cross-sectional area and introduction of any compressed gas induces a significant transfer of a significant portion of the volatile contaminants dissolved in the liquid phase to into the vapor phase. Thus, the contaminated liquid extract is effectively stripped of a large portion of its contaminant VOC's prior to being separated from the entrained vapor phase. For example, it has been observed that over 80 percent of VOC's in contaminated groundwater may be transferred from the liquid phase to the vapor phase in one pass through the stripper. Inline stripping according to the invention has been observed to be particularly effective in removing MtBE from contaminated groundwater.

Once the extracted fluid has been treated in the stripper 30, the liquid and vapor phase material is conducted, collected and separated as at conduit 50 into a vapor/liquid separator 52. Alternatively, the material processed through the inline stripper 30 may be conducted directly from the expansion chamber portion 36 into the separator 52. The separator 52 may be a conventional “knockout” vessel or drum in which the liquid and vapor phases are caused to separate primarily by means of gravity forces. The knockout vessel may also include an internal mist eliminator to aid in removal of fine liquid droplets from the vapor phase flow. The separator 52 may also be provided as a vessel packed with particulates such as a sand filter vessel where separation is enhanced by flow separation for improved mass transfer. A suitable size for the vapor /liquid separator vessel (in the case of a knockout vessel) is from about 50 to about 200 gals for an extract flow rate of from about 1 to about 20 gpm of liquids and from about 100 to about 1000 cfm of vapors, although it will appreciated that the separator 52 may be sized by those of ordinary skill in accordance with the flow rates involved in the particular application of the treatment system.

According to the invention, the resultant vapor stream 54 is thus substantially enriched VOC contaminant species while the resultant liquid stream 56 is substantially freed of such contaminants. As noted previously, up to 80 to 90 percent of the VOCs contaminants are expected to be removed from the liquid phase and transferred to the vapor phase in a single pass through the inline stripper.

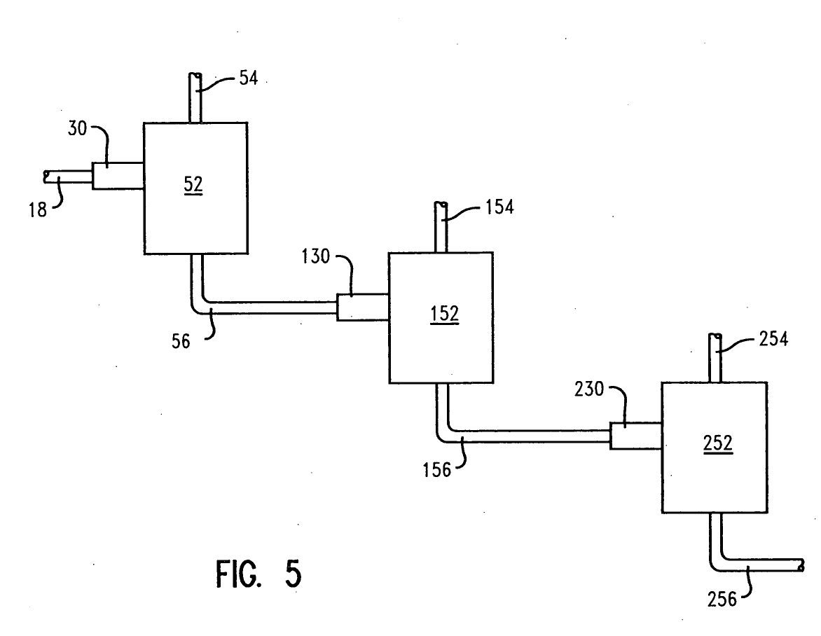

Still higher levels of contaminant removal may be achieved by employing a plurality of inline strippers and collectors/separators and passing the extract through the strippers and separators in series. An exemplary system is seen in FIG. 5 wherein the extract from the first stripper 30 and separator 52 is passed by conduit 56 to a second stripper 130 which operates in a like manner as stripper 30. The second stripper flows into a second separator 152 having a second vapor conduit 154 and a second extract conduit 156. Conduit 156, in turn flows into the third inline stripper 230 and subsequently third separator 252. Again, inline stripper 230 and separator 252 are constructed and function in a manner substantially like first stripper 30 and separator 52. Of course, a greater or lesser number of strippers and separators may be employed depending on operational requirements.

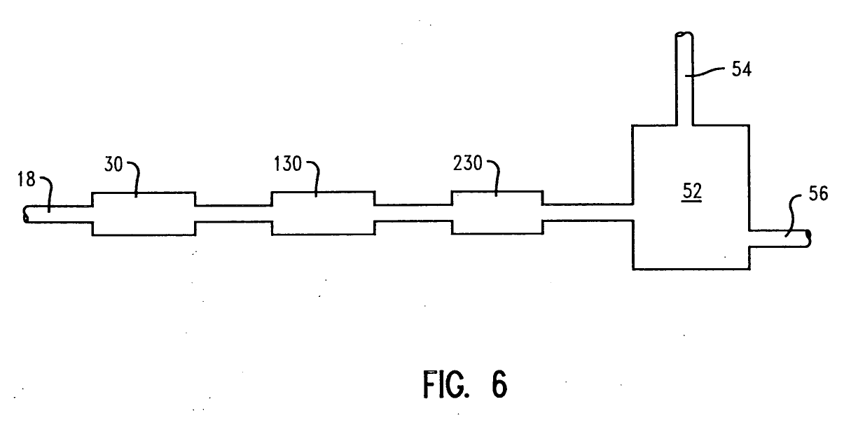

More preferably, however, the extract is passed through a plurality of inline strippers 30, 130, 230 which are directly connected in series with one another as illustrated in FIG. 6. In this configuration, the vapors and liquids are not separated between successive inline strippers. Thus the extract which is stripped in each instance includes both the vapor and liquid phases of the extract. Some remixing of the liquid and vapor phases may thus occur as the extract passes between strippers. However, it is been observed that only a minimal amount of volatile contaminants are retransferred to the liquid phase during this mixing. This minimal amount of remixing is offset by the cost saving realized by elimination of the multiple liquid/vapor separators which would be necessary to prevent the liquid and vapor phases from remixing.

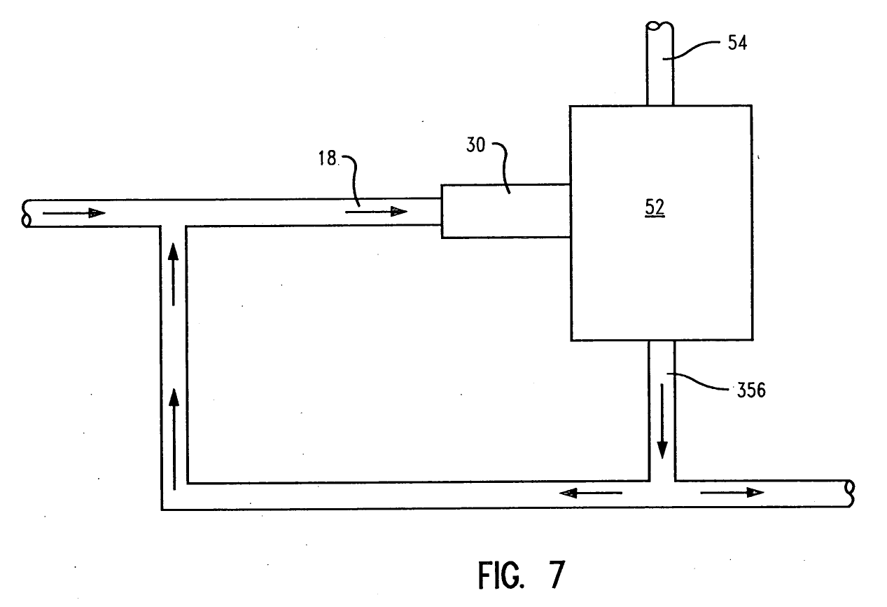

The system may also be configured to recycle or recirculate at least a portion of the liquid phase component of the stripped extract to the groundwater entering the stripper 30 from the conduit 18. The recycle is shown in FIG. 7 wherein the liquid extract conduit 356 which collects liquids from the separator splits the flow of extract and returns a portion of the same to the inline stripper 30. And, in a system employing two or more inline strippers in series, the recycling of at least a portion of any downstream stripped liquid phase portion of the extract may be accomplished such as by recycling stripped liquid phase material from the first stripper to extract flow entering the first stripper, recycling stripped liquid phase material from the second stripper to extract flow entering the first stripper and/or stripped liquid phase material entering the second stripper, etc. By the use of multiple strippers in series and use of recycling, the invention may achieve very high VOC separation efficiencies in the order of 95% or greater.

As a result, the liquid phase 56 emerging from the separator 52 may be a flow of substantially clean groundwater. In many instances, the contaminant levels in the groundwater are sufficiently reduced after a single pass through the inline stripper 30 that the water may be directly discharged from the separator 52 back into the environment without any further treatment.

However, if desired or if mandated by particular environmental regulations the separated liquid phase 56 may be further treated to further reduce its contaminant level. Suitable technologies for further remediating the liquid phase include packed tower air stripping, treatment with activated carbon, and ultraviolet oxidation.

The separated vapor phase stream 54 which contains most of the VOC's collected from the extract may also be treated to recover and/or destroy the contaminants. For instance, contaminant in the vapor phase may be recovered by absorption onto activated carbon or the vapors may be reactively destroyed such as by combustion if the contaminant is sufficiently flammable or by means of chemical reaction using reagents and treatments known to those c-f ordinary skill. Of course if the contaminants levels are within permissible limits, the vapors may also be discharged directly to the atmosphere.

The following nonlimiting examples illustrate various additional aspects of the invention.

### EXAMPLE 1

A site believed to have groundwater contaminated with methyl tertiary butyl ether (MtBE) from a leaking underground fuel tank was treated by extracting and treating the contaminated groundwater ex situ. An extraction well was formed by drilling a borehole down to the groundwater level of approximately 12 feet below the surface. Initial samples of the groundwater were taken and indicated an average MtBE concentration in the well of about 29,000 parts per billion (ppb). A one-inch diameter extraction pipe was placed in the well with its inlet opening approximately one to two feet below the groundwater level and contaminated water was extracted to the surface. The water was extracted under a partial vacuum using a SUTORBILT3L blower capable of producing a vacuum of 10 inches of mercury in the extraction pipe at the inlet opening sufficient to cause water to be drawn up to the surface.

The extracted groundwater was conducted through an ARTX Model 15008 air amplifier having an inlet diameter of about 2 inches and an outlet diameter of about 1.25 inches. A 25 cfm flow of compressed air was injected into the groundwater extract as it passed through the throat of the air amplifier. The compressed air was injected at a pressure of about 80 psig and a temperature of about 80° F. As the air/groundwater mixture exited the air amplifier, the mixture passed through a misting chamber wherein turbulence and misting resulted in a substantial portion of the dissolved contaminant MtBE being stripped from the groundwater, passing into the gaseous phase.

The air/groundwater mixture was then separated using a converted 500 gallon liquid-vapor separator. The resultant liquid phase was collected in 55 gallon drums. The vapor phase was passed through a 55 gallon drum of activated carbon to remove the volatile contaminant vapors via adsorption. The vapors were then discharged to the atmosphere.

Samples of the liquid phase were taken and examined for MtBE contaminants. The average MtBE level was found to be about 2,550 ppb, a reduction of about 26,450 ppb from the average initial MtBE concentration in the well extract

Having now described various aspects of the invention and preferred embodiments thereof, it will be recognized by those of ordinary skill that numerous modifications, variations and substitutions may exist within the spirit and scope of the appended claims.

1. A method for treatment of groundwater in a subterranean formation and contaminated by the presence of dissolved volatile organic compounds (VOC's) which comprises:
establishing a well extending from the ground surface to a downhole location adjacent contaminated groundwater in the subterranean formation in order to allow withdrawal of a two-phase extract including an undissolved vapor phase and a liquid phase which comprises contaminated groundwater containing dissolved VOC's to the surface through the well for treatment;
conducting the two-phase extract from the downhole location through the well to the surface;
stripping the contaminated groundwater of the liquid phase of the extract by expanding the flow of the extract in an inline stripper to induce transfer of VOC's from the contaminated groundwater to the undissolved vapor phase; and
separating the stripped extract into substantially liquid only and substantially vapor only process streams

2 (Cancelled).

3. The method of claim 1 further comprising separating VOC'S from the vapor process stream.

4. The method of claim 1 wherein a subatmospheric pressure is imposed upon the groundwater within the well to promote withdrawal of the same to the surface and separation of VOC's.

5. The method of claim 1 wherein the VOC'S comprise methyl tertiary butyl ether (MtBE).

6. The method of claim 1 wherein at least about 80% of the VOC'S are stripped from the groundwater to the vapor phase in a single pass.

7. The method of claim 1 wherein the extract is accelerated in the inline stripper and then released into a relatively low pressure area to induce transfer of VOC's into the vapor phase.

8. The method of claim 7 further comprising injecting compressed air into the extract flowing through the inline stripper.

9. The method of claim 1 wherein the liquid and vapor phases are separated in a knockout vessel.

10. The method of claim 1 further comprising repeating the step of stripping the contaminated groundwater by passing the stripped groundwater from the inline stripper through at least one additional inline stripper.

11. The method of claim 1 further comprising recycling at least a portion of the stripped groundwater from the inline stripper to the extract withdrawn to the surface and restripping the same together with the extract in the inline stripper.

12. An apparatus for treatment of groundwater in a subterranean formation, said groundwater being contaminated by the presence of VOC's, including VOC's dissolved in the groundwater comprising:
at least one well extending from the ground surface to a downhole location adjacent contaminated groundwater in the subterranean formation in order to allow withdrawal of a two-phase extract including an undissolved vapor phase and a liquid phase wherein the liquid phase includes contaminated groundwater containing dissolved VOCs through the well to the surface through the well;
a stripper unit containing an inline stripper connected in flow communication with the well for stripping the dissolved VOC's from the contaminated groundwater of the liquid phase of the extract by means of expansion of the flow of the extract in the inline stripper inducing transfer of VOC's from the groundwater to the undissolved vapor phase so that the material flow exiting the stripper contains a vapor phase enriched in VOC's and a liquid phase depleted in VOC's;
means for causing a flow of the two-phase extract including contaminated groundwater from the subterranean formation into and through the well to the surface and through the inline stripper of the stripper unit; and
a collector connected in flow communication with the material exiting the inline stripper for collecting the liquid phase and the vapor phase in separate substantially liquid only and a substantially vapor only phases.

13 (Cancelled).

14. The apparatus of claim 12 further comprising a vacuum source connected in flow communication with the well and the stripper unit for imposing a subatmospheric pressure upon the extract through the well to induce a flow of extract from the subterranean formation through the well to the surface, and into and through the inline stripper.

15 (Cancelled).

16. The apparatus of claim 12 wherein the inline stripper is configured to cause at least about 80% of the VOC's to be removed from the groundwater to the vapor phase in a single pass through the stripper.

17. The apparatus of claim 12 wherein the inline stripper comprises a flow through conduit having an inlet into which extract including groundwater flows and an exit from which the vapor and liquid phases pass to the collector and wherein the conduit includes a flow expander section downstream of the inlet through which groundwater from the extract flows and is released into an expanded cross-sectional area such that, upon entering the expanded cross-sectional area, a turbulence, mixing, and misting of the flow is induced to promote separation of the VOC's from the groundwater into the vapor phase.

18. The apparatus of claim 17 further comprising a source of compressed gas connected in flow communication with the inline stripper for introducing a flow of compressed gas into the stripper conduit in the expander section upstream of the expanded cross-sectional area in order to further promote separation of VOC's from the groundwater into the vapor phase.

19. The apparatus of claim 12 wherein the collector comprises a knockout vessel into which material is passed and being configured and dimensioned to promote separation of the liquid and vapor phases by the force of gravity acting upon the liquid phase.

20. The apparatus of claim 12, further comprising a plurality of inline strippers.

21. A method for treating groundwater from a subterranean formation wherein the groundwater is contaminated by the presence of dissolved volatile organic compounds (VOC's) which comprises conducting a flow of a two-phase extract including an undissolved vapor phase and a liquid phase wherein the liquid phase includes contaminated groundwater through a stripper conduit wherein the two-phase extract flow is expanded to promote separation of dissolved VOC's from the liquid phase of the extract groundwater by being rapidly decelerated from a first flow velocity to a substantially lower flow velocity than the first flow velocity in an expanded cross-sectional area of the stripper conduit containing a gas space and wherein deceleration of the flow velocity of the extract upon entering the expanded cross-sectional area causes substantially increased turbulence, mixing, and misting of the extract to induce transfer of dissolved VOC's from the groundwater of the liquid phase to undissolved gas in the gas space within the expanded area so that the expanded area of the conduit contains a two-phase flow comprising a flowing liquid phase with a reduced VOC content compared to that of the entering groundwater and a flowing gas phase including VOC's transferred thereto from the groundwater entering the expanded area and, thereafter, conducting the flowing liquid and gas phases from the stripping conduit into a collector vessel and effectively separating and collecting the liquid and gas phases into separate and distinct substantially liquid and substantially vapor only flow streams exiting the collector vessel for further treatment and/or disposal.

22. The method of claim 21 wherein the VOC's include methyl tertiary butyl ether (MtBE) and wherein at least a substantial portion of the MtBE is transferred from the groundwater to the gas phase.

23. The method of claim 21 wherein the ratio of the flow velocities of the first flow velocity and the lower flow velocity is from about 1.5 to about 10.

24. The method of claim 21 further comprising accelerating the flow of extract in the stripper conduit to the first flow velocity from a first relatively lower flow velocity of extract entering the stripper conduit.

25. The method of claim 21 wherein the flow velocity is accelerated to the first flow velocity by conducting the extract through a reduced cross-sectional area in relation to the cross-sectional area of the stripper conduit in an expander section upstream thereof carrying extract flowing at the first relatively lower flow velocity and in relation to the expanded cross-sectional area of the stripper conduit containing a gas or vapor space downstream of the reduced cross-sectional area.

26. The method of claim 21, further comprising pumping extract from the subterranean area into the stripper conduit so that extract flowing into the expanded cross-sectional area is under greater than atmospheric pressure.

27. The method of claim 21, further comprising injecting compressed gas into the extract flowing in the stripper conduit at a location in the conduit upstream of the expanded cross-sectional area.

28. The method of claim 21 wherein the compressed gas comprises compressed air at a pressure in the range of from about 20 to about 150 psig.

29. The method of claim 21 wherein the compressed gas is supplied at a volumetric flow ratio in relation to the flow of groundwater in the range of from about 10 to about 50 and at a pressure in the range of from about 20 to about 150 psig.

30. The method of claim 21, wherein the ratio of the length of the expanded cross-sectional area portion of the stripper conduit in relation to the cross-sectional area just upstream thereof is in the range of from about 5 to about 50.

31. The method of claim 21, wherein the ratio of the cross-sectional area of the expanded area portion of the stripper conduct in relation to the cross-sectional area of the conduit just upstream thereof is in the range of from about 10 to about 30.

32. The method of claim 21, further comprising, following separation of the gas and liquid phases, recycling at least a portion of the separated liquid phase so that recycled liquid phase material is mixed with extract entering the stripping conduit.

33. The method of claim 32, further comprising conducting at least a portion of the groundwater from the stripper conduit through a second stripper conduit arranged in series, flow communication with the first stripper conduit and further stripping the groundwater in the second stripper conduit.
